(19) United States
(12) Patent Application Publication
(10) Pub. No.: US 2025/0014543 A1
(43) Pub. Date: Jan. 9, 2025

(54) DATA OUTPUT METHOD AND DATA OUTPUT DEVICE

(71) Applicant: YAMAHA CORPORATION, Hamamatsu-shi (JP)

(72) Inventors: Akira MAEZAWA, Hamamatsu-shi (JP); Takuma TAKEMOTO, Hamamatsu-shi (JP)

(21) Appl. No.: 18/891,161

(22) Filed: Sep. 20, 2024

Related U.S. Application Data
(63) Continuation of application No. PCT/JP2023/009387, filed on Mar. 10, 2023.

(30) Foreign Application Priority Data
Mar. 25, 2022 (JP) 2022-049836

(51) Int. Cl. G10H 1/00

(52) U.S. Cl. CPC G10H 1/0008; G10H 2210/066; G10H 2210/076; G10H 2210/325

(57) ABSTRACT

A data output method according to one embodiment includes: sequentially acquiring input data related to a musical playing operation; obtaining a plurality of estimation information including first estimation information and second estimation information by providing the input data to a plurality of estimation models including a first estimation model and a second estimation model; identifying a musical score playing position based on the plurality of estimation information; and reproducing and outputting predetermined data based on the musical score playing position. The first estimation model indicates a relationship between performance data relating to the performance operation and a sheet music position in prescribed sheet music. The second estimation model is obtained by learning a relationship between the performance data and an intra-measure position.

### CROSS-REFERENCE TO RELATED APPLICATIONS

This application is a Continuation of International Patent Application No. PCT/JP2023/009387, filed on Mar. 10, 2023, which claims the benefit of priority to Japanese Patent Application No. 2022-049836, filed on Mar. 25, 2022, the entire contents of which are incorporated herein by reference.

### FIELD

The present disclosure relates to a technique to output data.

### BACKGROUND

Techniques have been proposed for identifying a playing position on a musical score in a predetermined musical piece by analyzing sound data obtained by a user's performance for the musical piece. For example, Japanese laid-open patent publication No. 2017-207615 also proposes a technique for realizing an automatic playing following a performance performed by a user by applying this technique to the automatic playing.

### SUMMARY

According to an embodiment of the present disclosure, there is provided a data output method including sequentially obtaining input data related to a musical playing operation, obtaining a plurality of estimation information including first estimation information and second estimation information by providing the input data to a plurality of estimation models including a first estimation model and a second estimation model, identifying a musical score playing position corresponding to the input data based on the plurality of estimation information, and reproducing and outputting predetermined data based on the musical score playing position. The first estimation model is a model that indicates a relationship between musical playing operation data related to a musical playing operation and a musical score position in a predetermined musical score, and outputs the first estimation information associated with a musical score position corresponding to the input data in response to the input data being provided. The second estimation model is a model that indicates a relationship between the musical playing operation data and a position in a measure, and outputs the second estimation information associated with a position in a measure corresponding to the input data in response to the input data being provided.

### BRIEF DESCRIPTION OF DRAWINGS

FIG. 1 is a diagram for explaining a system configuration in a first embodiment.

FIG. 2 is a diagram illustrating a configuration of an electronic musical instrument in the first embodiment.

FIG. 3 is a diagram illustrating a configuration of a data output device in the first embodiment.

FIG. 4 is a diagram illustrating a musical playing following function in the first embodiment.

FIG. 5 is a diagram illustrating a data output method in the first embodiment.

FIG. 6 is a diagram illustrating a musical score position model in a second embodiment.

FIG. 7 is a diagram illustrating a data-generating function in a third embodiment.

FIG. 8 is a diagram illustrating a model-generating function for generating a musical score position model in a fourth embodiment.

FIG. 9 is a diagram illustrating a model-generating function for generating an intra-measure position model in the fourth embodiment.

FIG. 10 is a diagram illustrating a model-generating function for generating a beat position model in the fourth embodiment.

### DESCRIPTION OF EMBODIMENTS

The accuracy with which an automatic playing follows a user's performance is influenced by the accuracy of an identified playing position. The accuracy of identifying a playing position may be reduced due to a note string or the like constituting a musical piece.

According to the present disclosure, it is possible to improve the accuracy in identifying a playing position on a musical score based on a user's performance.

Hereinafter, an embodiment of the present disclosure will be described in detail with reference to the drawings. The following embodiments are examples, and the present disclosure should not be construed as being limited to these embodiments. In the drawings referred to in the embodiments described below, the same or similar parts are denoted by the same reference signs or similar reference signs (signs only adding A, B, and the like after numbers), and repetitive description thereof may be omitted. The drawings may be schematically described by omitting a part of a configuration from the drawings for clarity of description.

### First Embodiment

### [Outline]

A data output device according to an embodiment of the present disclosure follows a user's performance of a predetermined musical piece on an electronic musical instrument and realizes an automatic playing for the predetermined musical piece. In this example, the electronic musical instrument is an electronic piano, and the musical instrument to be automatically played is a vocal. The data output device provides the user with singing sound obtained by the automatic playing and a video including an image imitating the singer. According to this data output device, it is possible to identify the position on the musical score played by the user with high accuracy by a musical playing following function described later. Hereinafter, the data output device and a system including the data output device will be described.

### [System Configuration]

FIG. 1 is a diagram for explaining a system configuration in a first embodiment. The system shown in FIG. 1 includes a data output device 10 and a data management server 90 connected via a network NW such as the Internet. In this example, an electronic musical instrument 80 is connected to the data output device 10. In this example, the data output device 10 is a computer such as a smartphone, a tablet personal computer, a laptop personal computer, or a desktop personal computer. In this example, the electronic musical instrument 80 is an electronic keyboard device, such as an electronic piano.

In the case where the user plays a predetermined musical piece using the electronic musical instrument 80 as described above, the data output device 10 has a function (hereinafter referred to as a musical playing following function) for executing an automatic playing following the performance and outputting data based on the automatic playing. Details of the data output device 10 will be described later.

The data management server 90 includes a control unit 91, a memory unit 92, and a communication unit 98. The control unit 91 includes a processor such as a CPU and a storage device such as a RAM. The control unit 91 executes a program stored in the memory unit 92 using the CPU, thereby performing a process according to an instruction described in the program. The memory unit 92 includes a storage device such as a non-volatile memory or a hard disk drive. The communication unit 98 includes a communication module for communicating with other devices by connecting to the network NW. The data management server 90 provides musical piece data to the data output device 10. The musical piece data is data related to the automatic playing, and details thereof will be described later. In the case where the musical piece data is provided to the data output device 10 in other ways, the data management server 90 may be omitted.

### [Electronic Musical Instrument]

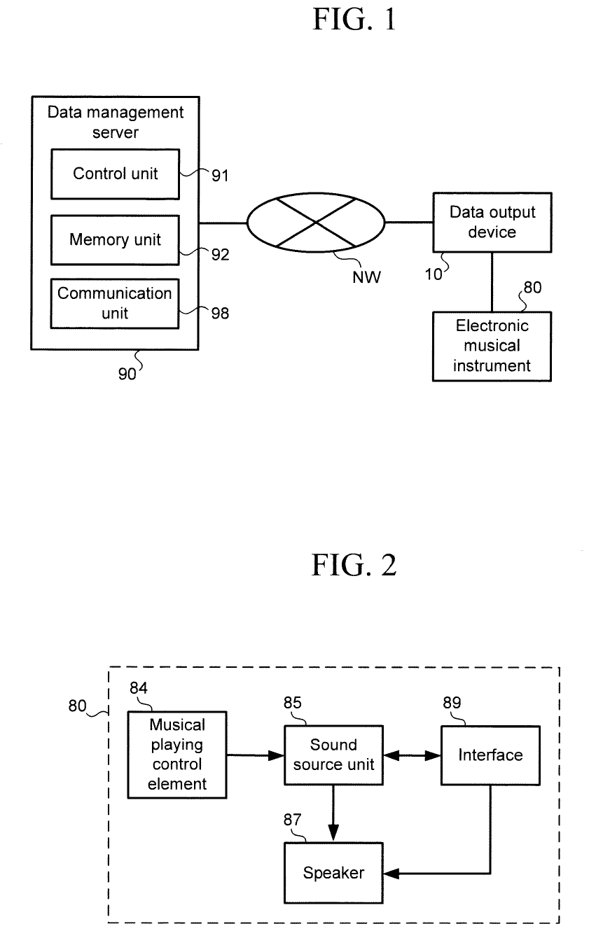

FIG. 2 is a diagram illustrating a configuration of an electronic musical instrument in the first embodiment. In this example, the electronic musical instrument 80 is an electronic keyboard device, such as an electronic piano, and includes a musical playing control element 84, a sound source unit 85, a speaker 87, and an interface 89. The musical playing control element 84 includes a plurality of keys and outputs a signal corresponding to an operation of each key to the sound source unit 85.

The sound source unit 85 includes a DSP (Digital Signal Processor) and generates sound data (musical playing operation sound data) including a sound waveform signal according to an operation signal. The operation signal corresponds to a signal output from the musical playing control element 84. The sound source unit 85 converts the operation signal into sequence data (hereinafter, referred to as operation data) in a predetermined format for controlling generation of a sound (hereinafter, referred to as sound generation) and outputs the sequence data to the interface 89. In this example, the predetermined format is a MIDI format. As a result, the electronic musical instrument 80 can transmit the operation data corresponding to the musical playing operation to the musical playing control element 84 to the data output device 10. For example, the operation data is information that defines the content of sound generation and is sequentially output as sound generation control information such as note-on, note-off, and note number. The sound source unit 85 may provide the sound data to the speaker 87 along with or instead of providing the sound data to the interface 89.

The speaker 87 may convert the sound waveform signal according to the sound data provided from the sound source unit 85 into an air-vibration and provide the air-vibration to the user. The sound data may be provided to the speaker 87 from the data output device 10 via the interface 89. The interface 89 includes a module for wirelessly or via wires transmitting and receiving data to and from an external device. In this example, the interface 89 is connected to the data output device 10 by wire, and transmits the operation data and the sound data generated by the sound source unit 85 to the data output device 10. These data may be received from the data output device 10.

### [Data Output Device]

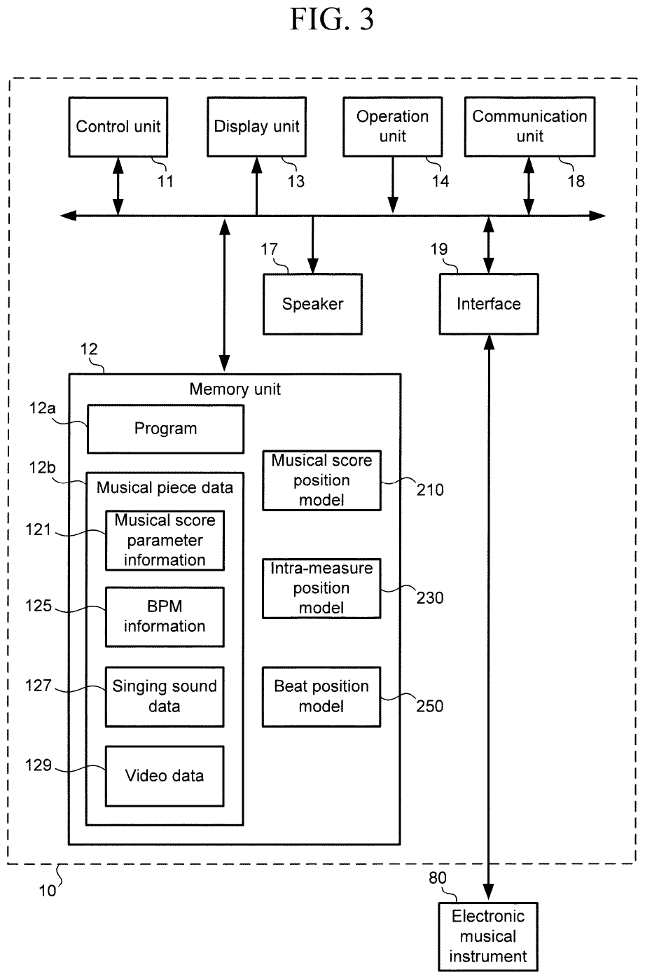

FIG. 3 is a diagram illustrating a configuration of a data output device in the first embodiment. The data output device 10 includes a control unit 11, a memory unit 12, a display unit 13, an operation unit 14, a speaker 17, a communication unit 18, and an interface 19. The control unit 11 is an example of a computer including a processor such as a CPU and a storage device such as a RAM. The control unit 11 executes a program 12a stored in the memory unit 12 using the CPU (processor), and causes the data output device 10 to realize functions for executing various processes. The functions realized in the data output device 10 include a musical playing following function described later.

The memory unit 12 is a storage device such as a non-volatile memory or a hard disk drive. The memory unit 12 stores various data such as the program 12a executed by the control unit 11 and the musical piece data 12b required when the program 12a is executed. The memory unit 12 stores three learned models obtained by machine learning. The learned model stored in the memory unit 12 includes a musical score position model 210, an intra-measure position model 230, and a beat position model 250.

The program 12a is downloaded from the data management server 90 or another server through the network NW and stored in the memory unit 12 to be installed in the data output device 10. The program 12a may be provided in a state of being recorded on a non-transitory computer-readable recording medium (for example, a magnetic recording medium, an optical recording medium, a magneto-optical recording medium, a semiconductor memory, or the like). In this case, the data output device 10 may include a device that reads the recording medium. The memory unit 12 is also an example of the recording medium.

Similarly, the musical piece data 12b may be downloaded from the data management server 90 or another server through the network NW and stored in the memory unit 12, or may be provided in a state of being recorded in a non-transitory computer-readable recording medium. The musical piece data 12b is data stored in the memory unit 12 for each musical piece, and includes musical score parameter information 121, BPM information 125, singing sound data 127, and video data 129. The musical piece data 12b, the musical score position model 210, the intra-measure position model 230, and the beat position model 250 will be described later.

The display unit 13 is a display having a display area that displays various screens based on the control of the control unit 11. The operation unit 14 is an operation device that outputs a signal corresponding to the operation by the user to the control unit 11. The speaker 17 generates sound by amplifying and outputting sound data supplied from the control unit 11. The communication unit 18 is a communication module that is connected to the network NW under the control of the control unit 11 and communicates with other devices such as the data management server 90 connected to the network NW. The interface 19 includes a module for communicating with an external device by wireless communication such as infrared communication or short-range wireless communication or wired communication. In this example, the external device includes the electronic musical instrument 80. The interface 19 is used to communicate without going through a networked NW.

### [Learned Models]

Next, three learned models will be described. As described above, the learned models include the musical score position model 210, the intra-measure position model 230, and the beat position model 250. The learned models are examples of an estimation model that outputs an output value and a likelihood as estimation information for an input value. Although known statistical estimation models are applied to any of the learned models, different models may be applied each other. For example, the estimation model is a machine learning model using a neural network using CNN (Convolutional Neural Network), RNN (Recurrent Neural Network), and the like. The estimation model may be a model using LSTM (Long Short Term Memory), GRU (Gated Recurrent Unit) or the like, or a model not using a neural network such as HMM (Hidden Markov Model). Each estimation model is preferably a model that is advantageous for handling time-series data.

The musical score position model 210 (first estimation model) is a learned model obtained by causing machine learning of a correlation between musical playing operation data and a position on a musical score (hereinafter referred to as a musical score position) in a predetermined score. In this example, the predetermined musical score is musical score data indicating a musical score of a piano part in a target musical piece, and is described as time-series data in which time information and the sound generation control information are associated with each other. The musical playing operation data is data obtained by various performers playing while looking at the target musical score, and is described as time-series data in which the sound generation control information and the time information are associated with each other. The sound generation control information is information that defines sound generation contents such as note-on, note-off, and note number. For example, the time information is information indicating a reproduction timing based on the start of the music, and is indicated by information such as a delta time and a tempo. In addition, the time information can be said to be information for identifying a position on the data and corresponds to the musical score position.

The correlation between the musical playing operation data and the musical score position indicates the correspondence between the sound generation control information arranged in time series in the musical playing operation data and the musical score data. That is, this correlation can be said that the data position of the musical score data corresponding to each data position of the musical playing operation data is indicated by the musical score position. The musical score position model 210 can also be said to be a learned model obtained by causing machine learning of the content of the performance (for example, how to play the piano) when various performers play while looking at the musical score.

When the input data corresponding to the musical playing operation data is sequentially provided, the musical score position model 210 outputs estimation information (hereinafter, referred to as musical score estimation information) including the musical score position and the likelihood according to the input data. For example, the input data corresponds to operation data sequentially output from the electronic musical instrument 80 in response to a musical playing operation to the electronic musical instrument 80. Since the operation data is information sequentially output from the electronic musical instrument 80, the time information may not be included while including information corresponding to the sound generation control information. In this case, time information corresponding to the time at which the input data is provided may be added to the input data.

The musical score position model 210 is a model obtained by machine learning for each target musical piece. Therefore, the musical score position model 210 can change the target musical piece by changing a parameter set (hereinafter, referred to as a musical score parameter) such as a weight coefficient in an intermediate layer. In the case where the musical score position model 210 is a model that does not use a neural network, the musical score parameter may be data corresponding to the model. For example, in the case where the musical score position model 210 uses DP (Dynamic Programming) matching for outputting the musical score estimation information, the musical score parameter may be the musical score data itself. The musical score position model 210 may not be the learned model obtained by machine learning, and it is sufficient to be a model that indicates a relationship between the musical playing operation data and the musical score position and outputs information corresponding to the musical score position and the likelihood when the input data is sequentially provided.

The intra-measure position model 230 (second estimation model) is a learned model obtained by causing machine learning of a correlation between the musical playing operation data and a position in one measure (hereinafter referred to as a position in a measure). For example, the position in a measure indicates any position from the start position to the end position in one measure, and for example, it is indicated by the number of beats and the inter-beat position. For example, the inter-beat position indicates a position in adjacent beats by a ratio. For example, if the musical playing operation data at a predetermined data position is a position corresponding to the center of the second beat and the third beat, the position in a measure may be described as “2.5” assuming that the number of beats is “2” and the inter-beat position is “0.5”. The position in a measure does not need to include the inter-beat position, and in this case, the position in a measure is information indicating in which beat the position is included. The position in a measure may be described by a ratio in which the start position of one measure is “0” and the end position of one measure is “1”.

The correlation between the musical playing operation data and the position in a measure indicates the correspondence between the sound generation control information arranged in time series in the musical playing operation data and the position in a measure. That is, the correlation can be said that indicating the position in a measure corresponding to each data position of the musical playing operation data. The intra-measure position model 230 can also be said to be a learned model obtained by learning the position in a measure when various performers play various musical pieces.

When the input data corresponding to the musical playing operation data is sequentially provided, the intra-measure position model 230 outputs estimation information (hereinafter referred to as “measure estimation information”) including the position in a measure and the likelihood corresponding to the input data. For example, the input data corresponds to operation data sequentially output from the electronic musical instrument 80 in response to the musical playing operation to the electronic musical instrument 80. The input data provided to the intra-measure position model 230 may be data from which information indicating a sound generation timing is extracted by removing information on pitch such as the note number from the operation data.

The intra-measure position model 230 is a model obtained by machine learning regardless of the musical piece. Therefore, the intra-measure position model 230 is commonly used for any musical piece. The intra-measure position model 230 may be a model obtained by machine learning for each beat of the musical piece (double beats, triple beats, and the like). In this case, the intra-measure position model 230 may change the target beat by changing a parameter set such as a weight coefficient in the intermediate layer. The target beat may be included in the musical piece data 12b. The intra-measure position model 230 may not be a learned model obtained by machine learning, and it is sufficient to be a model that indicates a relationship between the musical playing operation data and the position in a measure and outputs the information corresponding to the position in a measure and the likelihood when the input data is sequentially provided.

The beat position model 250 (third estimation information) is a learned model obtained by causing machine learning of a correlation between the musical playing operation data and a position within one beat (hereinafter referred to as a beat position). The beat position indicates any position from the start position to the end position in one beat. For example, the beat position may be described by a ratio in which the start position of the beat is “0” and the end position of the beat is “1”. The beat position may be described such that the start position of the beat is “0” and the end position of the beat is “2π” like a phase.

The correlation between the musical playing operation data and the beat position indicates the correspondence between the sound generation control information arranged in time series in the musical playing operation data and the beat position. That is, the correlation can be said that indicating a beat position corresponding to each data position of the musical playing operation data. The beat position model 250 can also be said to be a learned model obtained by learning a beat position when various performers play various musical pieces.

When the input data corresponding to the musical playing operation data is sequentially provided, the beat position model 250 outputs estimation information (hereinafter, referred to as beat estimation information) including the beat position and the likelihood corresponding to the input data. For example, the input data corresponds to operation data sequentially output from the electronic musical instrument 80 in response to the musical playing operation to the electronic musical instrument 80. The input data provided to the beat position model 250 may be data from which the information indicating the sound generation timing is extracted in such a manner that the information on the pitch such as the note number is excluded from the operation data.

The beat position model 250 is a model obtained by machine learning regardless of the musical piece. Therefore, the beat position model 250 is commonly used for any musical piece. In this example, the beat position model 250 corrects the beat estimation information based on the BPM information 125. The BPM information 125 is information indicating BPM (Beats Per Minute) of the musical piece data 12b. The beat position model 250 may recognize the BPM identified from the musical playing operation data as an integer fraction or an integer multiple of the actual BPM. The beat position model 250 can exclude an estimated value derived from a value far away from the actual BPM (for example, reduce the likelihood and the like) by using the BPM information 125, and as a result, the accuracy of the beat estimation information can be improved. The BPM info 125 may be used in the intra-measure position model 230. The beat position model 250 may not be the learned model obtained by machine learning, and it is sufficient to be a model that indicates a relationship between the musical playing operation data and the beat position, and outputs information corresponding to the beat position and the likelihood when the input data is sequentially provided.

### [Musical Piece Data]

Next, the musical piece data 12b will be described. As described above, the musical piece data 12b is data stored in the memory unit 12 for each musical piece and includes the musical score parameter information 121, the BPM information 125, a singing sound data 127, and the video data 129. In this example, the musical piece data 12b includes data for reproducing singing sound data following the user's performance.

As described above, the musical score parameter information 121 includes a parameter set used for the musical score position model 210 corresponding to a music piece. As described above, the BPM information 125 is information provided to the beat position model 250 and is information indicating the BPM of a musical piece.

The singing sound data 127 is sound data including a waveform signal of singing sound corresponding to a vocal part of a musical piece, and time information is associated with each part of the data. The singing sound data 127 can also be said to be data that defines the waveform signal of the singing sound in time series. The video data 129 is video data including an image imitating a singer of the vocal part, and time information is associated with each part of the data. The video data 129 can also be said to be data that defines data of the image in time series. This time information in the singing sound data 127 and the video data 129 is determined corresponding to the above-described musical score position. Therefore, the performance using the musical score data, the reproduction of the singing sound data 127, and the reproduction of the video data 129 can be synchronized via the time information.

The singing sound included in the singing sound data 127 may be generated using at least character information and pitch information. For example, the singing sound data 127 includes time information and the sound generation control information associated with the time information, similar to the musical score data. As described above, the sound generation control information includes the pitch information such as the note number, and further includes the character information corresponding to lyrics. That is, the singing sound data 127 may be control data for generating singing sound instead of the data including the waveform signal of the singing sound. The video data 129 may also be control data including image control information for generating the image imitating a singer.

### [Musical Playing Following Function]

Next, a musical playing following function realized by the control unit 11 executing the programming 12a will be described.

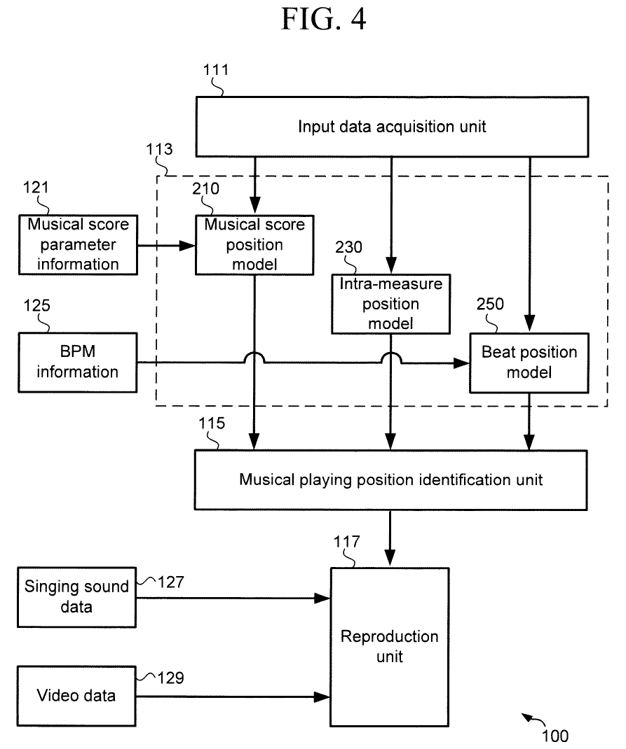

FIG. 4 is a diagram illustrating the musical playing following function in the first embodiment. The musical playing following function 100 includes an input data acquisition unit 111, a calculation unit 113, a musical playing position identification unit 115, and a reproduction unit 117. It is not limited to the case where the configuration for realizing the musical playing following function 100 is realized by execution of a program, and at least part of the configuration may be realized by hardware.

The input data acquisition unit 111 acquires the input data. In this example, the input data corresponds to the operation data sequentially output from the electronic musical instrument 80. The input data acquired by the input data acquisition unit 111 is provided to the calculation unit 113.

The calculation unit 113 includes the musical score position model 210, the intra-measure position model 230, and the beat position model 250, provides the input data to the respective models, and provides the estimation information (musical score estimation information, measure estimation information, and beat estimation information) output from the respective models to the musical playing position identification unit 115.

The musical score position model 210 functions as a learned model corresponding to a predetermined musical piece by setting a weight coefficient according to the musical score parameter information 121. As described above, the musical score position model 210 outputs musical score estimation information when input data is sequentially provided. This makes it possible to identify the likelihood for the musical score position with respect to the provided input data. That is, according to the musical score estimation information, it is possible to indicate which position on the musical score of the musical piece corresponds to a performance content of the user corresponding to the input data by the likelihood for each position.

The intra-measure position model 230 is a learned model that does not depend on a musical piece. The intra-measure position model 230 outputs the measure estimation information when the input data is sequentially provided. As a result, the likelihood for the position in a measure can be identified with respect to the provided input data. That is, according to the measure estimation information, it is possible to indicate which position in one measure corresponds to the performance content of the user corresponding to the input data by the likelihood for each position.

The beat position model 250 is a learned model that does not depend on a musical piece. The beat position model 250 outputs beat estimation information when the input data is sequentially provided. As a result, the likelihood for the beat position can be identified with respect to the provided input data. That is, according to the beat estimation information, it is possible to indicate which position in one beat corresponds to the performance content of the user corresponding to the input data by the likelihood for each position. As described above, the beat position model 250 may use the BPM information 125 as a pre-given parameter.

The musical playing position identification unit 115 identifies a musical score playing position based on the musical score estimation information, the measure estimation information, and the beat estimation information, and provides the musical score playing position to the reproduction unit 117. The musical score playing position is a position on the musical score identified corresponding to the performance on the electronic musical instrument 80. Although the musical playing position identification unit 115 can identify the musical score position having the highest likelihood in the musical score estimation information as the musical score playing position, in this example, the measure estimation information and the beat estimation information are further used in order to improve the accuracy. The musical playing position identification unit 115 corrects the musical score position in the musical score estimation information by the position in a measure in the measure estimation information and the beat position in the beat estimation information.

For example, the musical playing position identification unit 115 performs correction by the following method as a specific example. First, a first example will be described. The musical playing position identification unit 115 performs a predetermined calculation (multiplication, addition, or the like) using the likelihood determined for the musical score position, the likelihood determined for the position in a measure, and the likelihood determined for the beat position. The likelihood determined for the position in a measure is applied to each repeated measure in the musical score. The likelihood determined for the beat position is applied to each beat repeated in each measure. As a result, the likelihood at each musical score position is corrected by applying the likelihood determined for the position in a measure and the likelihood determined for the beat position. The musical playing position identification unit 115 identifies the musical score position having the highest corrected likelihood as the musical score playing position.

Next, a second example will be described. The musical playing position identification unit 115 performs a predetermined calculation (multiplication, addition, or the like) using the likelihood determined for the position in a measure and the likelihood determined for the beat position of each beat repeated in the measure. The likelihood determined for the beat position is applied to each beat repeated in each measure. As a result, the likelihood determined for the position in a measure is corrected by applying the determined likelihood for the beat position. The musical playing position identification unit 115 identifies the position in a measure at which the corrected likelihood is highest. The musical playing position identification unit 115 identifies the position in a measure of the measures including the musical score position having the highest likelihood identified in this way as the playing position of the musical score.

In the case where the musical score playing position is identified only from the musical score estimation information, the accuracy of identifying the musical score playing position may be deteriorated depending on the content of the musical piece. For example, if it is the performance of a part where the melody is clear, an accurate musical score position is easily identified. Therefore, it is possible to increase the accuracy of identifying the musical score playing position. On the other hand, the performance of a part with little change in melody is greatly influenced by an accompaniment. The accompaniment often does not rely on the musical piece, and it is difficult to identify an accurate musical score position. Therefore, in this example, even if there is a part where an accurate musical score position cannot be identified, the musical score estimation information can be corrected so as to increase the accuracy of the ambiguous musical score position by identifying the detailed position using the measure estimation information and the beat estimation information that are independent of the musical piece, and the accuracy of identifying the musical score playing position can be improved.

The reproduction unit 117 reproduces the singing sound data 127 and the video data 129 based on the musical score playing position provided from the musical playing position identification unit 115 and outputs them as reproduction data. The musical score playing position is a position on the musical score identified corresponding to the performance on the electronic musical instrument 80. Therefore, the musical score playing position is also related to the above-described time information. The reproduction unit 117 refers to the singing sound data 127 and the video data 129 and reads each part of the data corresponding to the time information identified by the musical score playing position, thereby reproducing the singing sound data 127 and the video data 129.

The reproduction unit 117 can synchronize the performance of the electronic musical instrument 80 by the user, the reproduction of the singing sound data 127, and the reproduction of the video data 129 through the musical score playing position and the time information by reproducing the singing sound data 127 and the video data 129 described above.

When the reproduction unit 117 reads the sound data based on the musical score playing position, the sound data may be read based on the relationship between the musical score playing position and the time information, and the pitch may be adjusted according to the reading speed. For example, the pitch may be adjusted so as to be the pitch when the sound data is read at a predetermined reading speed.

Among the reproduction data, the video data 129 is provided to the display unit 13, and the image of the singer is displayed on the display unit 13. Among the reproduction data, the singing sound data 127 is provided to the speaker 17 and is output as singing sound from the speaker 17. The video data 129 and the singing sound data 127 may be provided to an external device. For example, the singing sound may be output from the speaker 87 of the electronic musical instrument 80 by providing the singing sound data 127 to the electronic musical instrument 80. As described above, according to the musical playing following function 100, singing and the like can be accurately followed with respect to the user's performance. As a result, even if the user is playing alone, the user can obtain a sense of actually playing with a plurality of persons. Therefore, this provides the user with a highly realistic customer experience. The above is the description of the musical playing following function.

### [Data Output Method]

Next, a data output method executed by the musical playing following function 100 will be described. The data output method described here begin when the program 12a is executed.

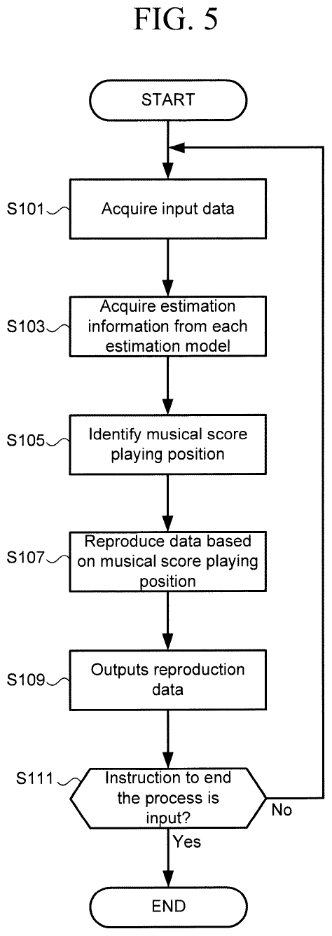

FIG. 5 is a diagram illustrating the data output method in the first embodiment. The control unit 11 acquires the input data to be sequentially provided (step S101) and acquires estimation information from each estimation model (step S103). In this example, the estimation model includes the musical score position model 210, the intra-measure position model 230, and the beat position model 250 described above. The estimation information includes the musical score estimation information, the measure estimation information, and the beat estimation information described above. The control unit 11 identifies the musical score playing position based on the estimation information (step S105). The control unit 11 reproduces the video data 129 and the singing sound data 127 based on the musical score playing position (step S107) and outputs the video data 129 and the singing sound data 127 as reproduction data (step S109). Until an instruction to end the process is input (step S111; No), the control unit 11 repeats the process from step S101 to step S109, and when the instruction to end the process is input (step S111; Yes), the control unit 11 ends the process.

### Second Embodiment

In the second embodiment, a configuration will be described in which at least one of the estimation models separates the input data into a plurality of sound ranges and includes the estimation model corresponding to the input data of each sound range. In this example, a configuration in which the configuration for dividing the sound range is applied to the musical score position model 210 will be described. Although the description is omitted, a configuration for dividing the sound range may be applied to at least one of the intra-measure position model 230 and the beat position model 250.

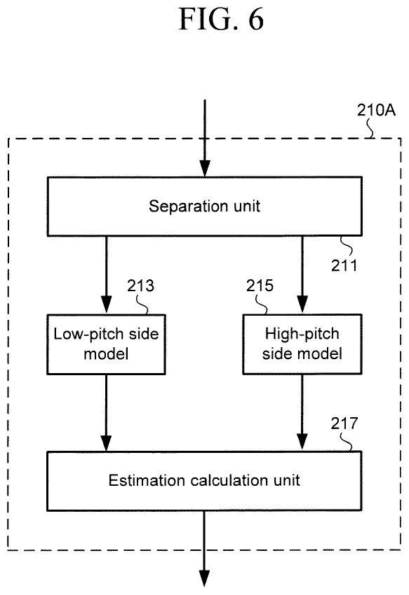

FIG. 6 is a diagram illustrating a musical score position model according to the second embodiment. A musical score position model 210A in the second embodiment includes a separation unit 211, a low-pitch side model 213, a high-pitch side model 215, and an estimation calculation unit 217. The separation unit 211 separates the input data into two sound ranges. For example, based on a predetermined pitch (for example, C4), the separation unit 211 separates the input data into high-pitch side input data obtained by extracting the sound generation control information related to the note number on the high-pitch side and low-pitch side input data obtained by extracting the sound generation control information related to the note number on the low-pitch side. Since the high-pitch side input data is obtained by extracting the performance in the pitch range on the high-pitch side, the high-pitch side input data mainly corresponds to the melody of the musical piece. Since the low-pitch side input data is obtained by extracting the performance in the pitch range on the low-pitch side, the low-pitch side input data mainly corresponds to the accompaniment of the musical piece. The input data provided to the musical score position model 210A may include the high-pitch side input data and the low-pitch side input data.

The low-pitch side model 213 has the same function as the musical score position model 210 in the first embodiment, and is different in that the musical playing operation data used for machine learning is in the same range as the low-pitch side input data. When the low-pitch side input data is provided, the low-pitch side model 213 outputs low-pitch side estimation information. The low-pitch side estimation information is information similar to the musical score estimation information, but is information obtained by using data in the low-pitch range.

The high-pitch side model 215 has the same function as the musical score position model 210 in the first embodiment, and is different in that the musical playing operation data used for machine learning is in the same range as the high-pitch side input data. When the high-pitch side input data is provided, the high-pitch side model 215 outputs the high-pitch side estimation information. The high-pitch side estimation information is information similar to the musical score estimation information, but is information obtained by using data in the high-pitch range.

The estimation calculation unit 217 generates the musical score estimation information based on the low-pitch side estimation information and the high-pitch side estimation information. The likelihood of the musical score position in the musical score estimation information may be a larger one of the likelihood of the low-side estimation information and the likelihood of the high-side estimation information at each musical score position, or may be calculated by a predetermined calculation (for example, addition) using each likelihood as a parameter.

By dividing the input data into the low-pitch side and the high-pitch side in this way, it is possible to improve the accuracy of the high-pitch side estimation information in a section where a melody of a musical piece is present. On the other hand, in a section where no melody is present, instead of lowering the accuracy of the high-pitch side estimation information, the low-pitch side estimation information that is less affected by the melody can be used.

### Third Embodiment

In the third embodiment, a data-generating function for generating the singing sound data and the musical score data from sound data indicating a musical piece (hereinafter referred to as musical piece sound data) and registering them in the data management server 90 will be described. The generated singing sound data is used as the singing sound data 127 included in the musical piece data 12b according to the first embodiment. The generated musical score data is used for machine learning in the musical score position model 210. In this example, the control unit 91 in the data management server 90 executes a predetermined program to realize a data-generating function.

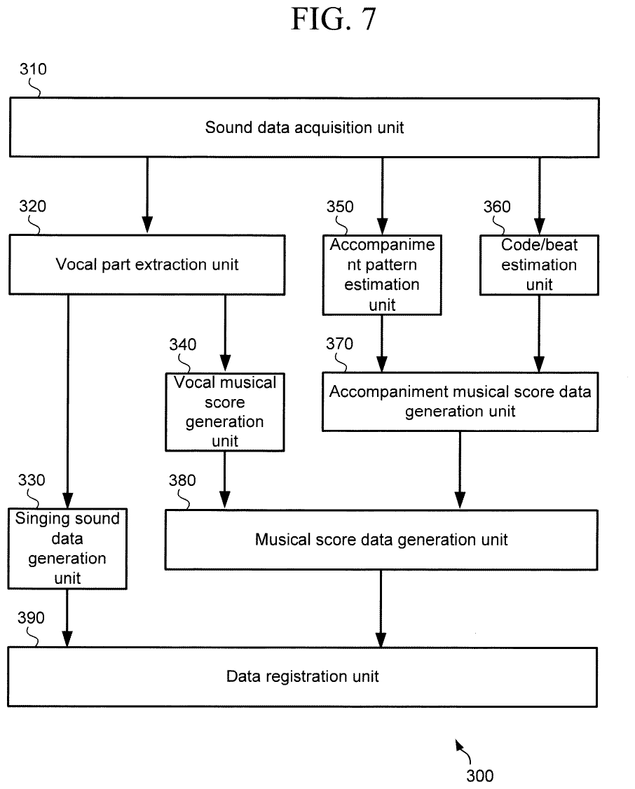

FIG. 7 is a diagram illustrating a data-generating function in the third embodiment. A data-generating function 300 includes a sound data acquisition unit 310, a vocal part extraction unit 320, a singing sound data generation unit 330, a vocal musical score data generation unit 340, an accompaniment pattern estimation unit 350, a code/beat estimation unit 360, an accompaniment musical score data generation unit 370, a musical score data generation unit 380, and a data registration unit 390. The sound data acquisition unit 310 acquires the musical piece sound data. The musical piece sound data is stored in the memory unit 92 of the data management server 90.

The vocal part extraction unit 320 analyzes the musical piece sound data by a known sound source separation technique, and extracts data of a part corresponding to the singing sound corresponding to the vocal part from the musical piece sound data. Examples of the known sound source separation technique include the technique disclosed in Japanese laid-open patent publication No. 2021-135446 and the like. The singing sound data generation unit 330 generates singing sound data indicating the singing sound extracted by the vocal part extraction unit 320.

The vocal musical score data generation unit 340 identifies the information of each sound included in the singing sound, for example, the pitch and the tone length, and converts the information into the sound generation control information indicating the singing sound and the time information. The vocal musical score data generation unit 340 generates time-series data in which the time information and the sound generation control information obtained by converting are associated with each other, that is, musical score data indicating the musical score of the vocal part of the target musical piece. For example, the vocal part corresponds to a part to be played by the right hand in the piano part, and includes a melody, that is, a melody sound, of singing sound. The melody sound is determined in a predetermined sound range.

The accompaniment pattern estimation unit 350 analyzes the musical piece sound data by a known estimation technique to estimate the accompaniment pattern in each section of the music piece. Examples of the known estimation technique include the technique disclosed in Japanese laid-open patent publication No. 2014-29425 and the like. The code/beat estimation unit 360 estimates a position of a beat of a musical piece and a chord progression (chord in each section) by the known estimation technique. Examples of the known estimation technique include the techniques disclosed in Japanese laid-open patent publication No. 2015-114361 and Japanese laid-open patent publication No. 2019-144485 and the like.

The accompaniment musical score data generation unit 370 generates the content of an accompaniment part based on the estimated accompaniment pattern, the position of the beat, and the chord progression, and generates musical score data indicating a musical score of the accompaniment part. This musical score data is time-series data in which the time information and the sound generation control information indicating the accompaniment sound of the accompaniment part are associated with each other, that is, musical score data indicating the musical score of the accompaniment part of the target musical piece. For example, the accompaniment part corresponds to a part to be played by the left hand in the piano part, and includes at least one of a chord sound and a bass sound corresponding to the chord. The chord sound and the bass sound are respectively determined in a predetermined sound range.

The accompaniment musical score data generation unit 370 may not use the estimated accompaniment pattern. In this case, for example, the accompaniment sound may be determined to generate a sound of the chord sound and the bass sound corresponding to the chord progression only when the chord is switched in at least some sections of the music piece. In particular, when the accompaniment sound is determined in this manner in a section where the melody sound is present has the effect of increasing redundancy for the user's performance, and the accuracy of the musical score estimation information generated in the musical score position model 210 can be improved.

The musical score data generation unit 380 synthesizes the musical score data of the vocal part and the musical score data of the accompaniment part to generate musical score data. As described above, the vocal part corresponds to the part played by the right hand in the piano part, and the accompaniment part corresponds to the part played by the left hand in the piano part. Therefore, it can be said that the musical score data indicates a musical score when the piano part is played with both hands.

The musical score data generation unit 380 may modify some data when generating the musical score data. For example, the musical score data generation unit 380 may modify the musical score data of the vocal part so as to add sounds separated by one octave for each sound in at least some sections. Whether the added sound is one octave above or below may be determined based on the sound range of the singing sound. That is, when the pitch of the singing sound is lower than the predetermined pitch, a sound of one octave above may be added, and when the pitch is higher than the predetermined pitch, a sound of one octave below may be added. In this case, it can be said that the musical score indicated by the musical score data has a parallel pitch one octave below the highest pitch. In this way, redundancy for the user's performance increases, and the accuracy of the musical score estimation information generated in the musical score position model 210 can be improved.

The data registration unit 390 registers the singing sound data generated in the singing sound data generation unit 330 and the musical score data generated in the musical score data generation unit 380 in a database stored in the memory unit 92 or the like in association with information for identifying a musical piece.

As described above, according to the data-generating function 300, analyzing the musical piece sound data makes it possible to extract the singing sound data and generate the musical score data corresponding to the musical piece.

### Fourth Embodiment

In the fourth embodiment, a model-generating function for generating an estimation model obtained by machine learning will be described. In this example, the control unit 91 in the data management server 90 executes a predetermined program to realize the model-generating function. In the example described above, the estimation model includes the musical score position model 210, the intra-measure position model 230, and the beat position model 250. Therefore, the model-generating function is also realized for each estimation model. The “teacher data” described below may be replaced with the expression “training data”. The expression “causing learning the model” may be replaced with the expression “train the model”. For example, the expression “the computer causes learning the learning model using the teacher data” may be replaced with the expression “the computer trains the learning model using the training data”.

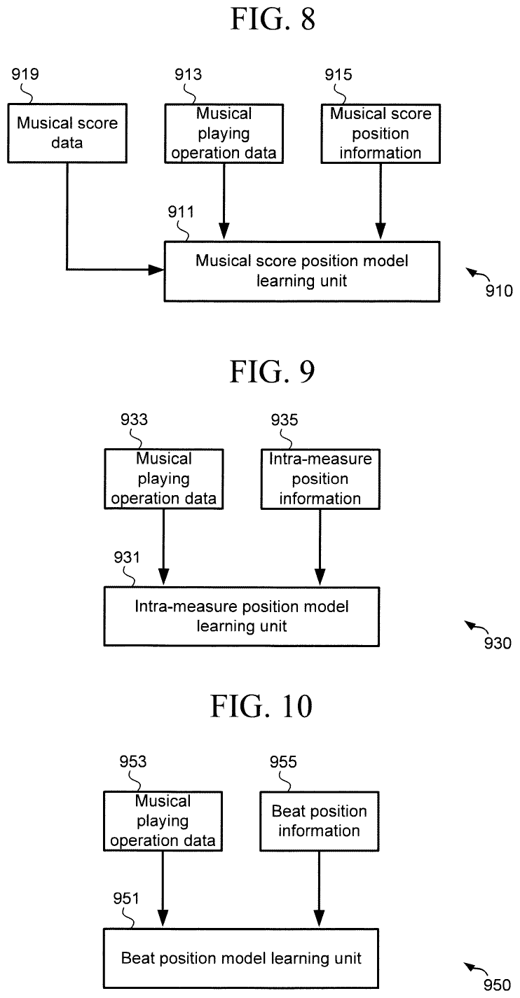

FIG. 8 is a diagram illustrating a model-generating function for generating a musical score position model in the fourth embodiment. The model-generating function 910 includes a machine learning unit 911. The machine learning unit 911 is provided with musical playing operation data 913, musical score position information 915, and musical score data 919. The musical score data 919 is musical score data obtained by the above-described data-generating function 300. The musical playing operation data 913 is data obtained by the performer playing while looking at the musical score corresponding to the musical score data 919, and is described as time-series data in which the sound generation control information and the time information are associated with each other. The musical score position information 915 is information indicating a correspondence between a position (playing position) in the performance indicated by the musical playing operation data 913 and a position (musical score position) in the musical score indicated by the musical score data 919. The musical score position information 915 can be said to be information indicating a correspondence between the time series of the musical playing operation data 913 and the time series of the musical score data 919.

A set of the musical playing operation data 913 and the musical score position information 915 corresponds to the teacher data in machine learning. A plurality of sets is prepared in advance for each musical piece and provided to the machine learning unit 911. The machine learning unit 911 uses the teacher data to execute machine learning for each piece of the musical score data 919, that is, for each piece of the musical piece, and generates the musical score position model 210 by determining the weight coefficient in the intermediate layer. In other words, the musical score position model 210 can be generated by causing the computer to learn the learning model using the teacher data. The weight coefficient corresponds to the musical score parameter information 121 described above and is determined for each piece of the musical piece data 12b.

FIG. 9 is a diagram illustrating a model-generating function for generating an intra-measure position model in the fourth embodiment. A model-generating function 930 includes a machine learning unit 931. The machine learning unit 931 is provided with musical playing operation data 933 and an intra-measure position information 935. The musical playing operation data 933 is data obtained by the performer playing while looking at a predetermined musical score and is described as time-series data in which the sound generation control information and time information are associated with each other. The predetermined musical score includes not only the musical score of a specific musical piece but also the musical score of various musical pieces. The intra-measure position information 935 is information indicating a correspondence between a position (playing position) in the performance indicated by the musical playing operation data 933 and the position in a measure. The intra-measure position information 935 may be referred to as information indicating a correspondence between the time series of the musical playing operation data 933 and the position in a measure.

A set of the musical playing operation data 933 and the intra-measure position information 935 corresponds to the teacher data in machine learning. A plurality of sets is prepared in advance and provided to the machine learning unit 931. The teacher data used in the model-generating function 930 does not depend on a musical piece. The machine learning unit 931 performs machine learning using the teacher data and generates the intra-measure position model 230 by determining the weight coefficient in the intermediate layer. In other words, it can be said that the intra-measure position model 230 is generated by causing the computer to learn the learning model using the teacher data. Since the weight coefficient does not depend on the musical piece, it can be used generically.

FIG. 10 is a diagram illustrating a model-generating function for generating a beat position model in the fourth embodiment. A model-generating function 950 includes a machine learning unit 951. The machine learning unit 951 is provided with musical playing operation data 953 and a beat position information 955. The musical playing operation data 953 is data obtained by the performer playing while looking at a predetermined musical score, and is described as time-series data in which the sound generation control information and the time information are associated with each other. The predetermined musical score includes not only the musical score of a specific musical piece but also the musical score of various musical pieces. The beat position information 955 is information indicating a correspondence between a position (playing position) in a performance indicated by the musical playing operation data 953 and a beat position. The beat position information 955 may be referred to as information indicating the correspondence between the time series of the musical playing operation data 953 and the beat position.

A set of the musical playing operation data 953 and the beat position information 955 corresponds to the teacher data in machine learning. A plurality of sets is prepared in advance and provided to the machine learning unit 951. The teacher data used in the model-generating function 950 does not depend on a musical piece. The machine learning unit 951 performs machine learning using the teacher data and generates the beat position model 250 by determining the weight coefficient in the intermediate layer. In other words, it can be said that the beat position model 250 is generated by causing the computer to learn the learning model using the teacher data. Since the weight coefficient does not depend on the musical piece, it can be used generically.

### [Modifications]

The present disclosure is not limited to the above-described embodiments, and includes various other modifications. For example, the above-described embodiments have been described in detail for the purpose of illustrating the present disclosure in an easy-to-understand manner, and are not necessarily limited to those having all the described configurations. Some modifications will be described below. Although the example will be described as a modification of the first embodiment, other embodiments can also be used as the modification. A plurality of modifications may be combined and applied to each embodiment.
(1) The plurality of estimation models included in the calculation unit 113 is not limited to the case where three estimation models of the musical score position model 210, the intra-measure position model 230, and the beat position model 250 are used, and it is also possible to use two estimation models. For example, the calculation unit 113 may not use either the intra-measure position model 230 or the beat position model 250. That is, in the musical playing following function 100, the musical playing position identification unit 115 may identify the musical score playing position using the musical score estimation information and the measure estimation information or may identify the musical score playing position using the musical score estimation information and the beat position estimation information. The musical score musical playing position identification unit 115 may identify the musical score playing position using only the musical score estimation information.
(2) The input data acquired by the input data acquisition unit 111 is not limited to the time-series data including the sound generation control information, and may be sound data including a waveform signal of a musical playing operation sound. In this case, the musical playing operation data used for the machine learning of the estimation model may be any sound data including the waveform signal of the musical playing operation sound. The musical score position model 210 in such a case may be realized by the known estimation technique. Examples of the known estimation technique include the techniques disclosed in Japanese laid-open patent publication No. 2016-99512 and Japanese laid-open patent publication No. 2017-207615. The input data acquisition unit 111 may convert the operation data in the first embodiment into sound data and acquire the sound data as input data.
(3) The sound generation control information included in the input data and the musical playing operation data may be incomplete information that does not include some information as long as the information can define the sound generation content. For example, the sound generation control information in the input data and the musical playing operation data may include the note-on and the note-number, and may not include the note-off, as the sound generation content that does not include a mute instruction. Sounds in part of the sound range among the musical piece may be extracted as the sound generation control information in the musical playing operation data. Musical playing operations in part of the sound range among the musical playing operations may be extracted as the sound generation control information in the input data.
(4) At least one of the video data and the sound data included in the reproduction data may not be present. That is, at least one of the video data and the sound data may follow the user's performance as an automatic processing.
(5) The video data included in the reproduction data may be still image data.
(6) The function of the data output device 10 and the function of the electronic musical instrument 80 may be included in one device. For example, the data output device 10 may be incorporated as a function of the electronic musical instrument 80. A part of the configurations of the electronic musical instrument 80 may be included in the data output device 10, or a part of the configurations of the data output device 10 may be included in the electronic musical instrument 80. For example, the configurations other than the musical playing control element 84 of the electronic musical instrument 80 may be included in the data output device 10. In this case, the data output device 10 may generate the sound data from the acquired operation data using the sound source unit. A part of the configuration of the data output device 10 may be included in the configuration other than the electronic musical instrument 80, for example, a server connected via the network NW, a terminal capable of direct communication, or the like. For example, the configuration of the calculation unit 113 among the musical playing following function 100 in the data output device 10 may be included in the server. By measuring the delay time due to communication via the network NW, the musical score playing position may be corrected according to the delay time. For example, the correction may include changing the musical score playing position to a future musical score position by an amount corresponding to the delay time.
(7) The control unit 11 may record the reproduction data output from the reproduction unit 117 on a recording medium or the like. The control unit 11 may generate data for recording for outputting the reproduction data and record the data on the recording medium. The recording medium may be the memory unit 12 or may be a computer-readable recording medium connected as an external device. The data for recording may be transmitted to a server device connected via the network NW. For example, the data for recording may be transmitted to the data management server 90 and stored in the memory unit 92. The data for recording may be a form including the video data and the sound data, or may be in a form including time-series information of the singing sound data 127, the video data 129, and the musical score playing position. In the second case, the reproduction data may be generated from the data for recording by a function corresponding to the reproduction unit 117.
(8) The musical playing position identification unit 115 may identify the musical score playing position regardless of the estimation data output from the calculation unit 113 during a part of the musical piece. In this case, in the musical piece data 12b, the progress velocity of the musical score playing position to be identified in a part of the musical piece may be defined. In this period of the part of the musical piece, the musical playing position identification unit 130 may identify that the musical score playing position is changed at the defined the progress velocity.

The above is the description of the modification.

As described above, according to an embodiment of the present disclosure, there is provided a data output method including sequentially obtaining input data related to a musical playing operation, obtaining a plurality of estimation information including first estimation information and second estimation information by providing the input data to a plurality of estimation models including a first estimation model and a second estimation model, identifying a musical score playing position corresponding to the input data based on the plurality of estimation information, and reproducing and outputting predetermined data based on the musical score playing position. The first estimation model is a model that indicates a relationship between musical playing operation data related to a musical playing operation and a musical score position in a predetermined musical score, and outputs the first estimation information associated with a musical score position corresponding to the input data when the input data is provided. The second estimation model is a model that indicates a relationship between the musical playing operation data and a position in a measure, and outputs the second estimation information associated with a position in a measure corresponding to the input data when the input data is provided.

The plurality of estimation models may include a third estimation model. The plurality of estimation information may include third estimation information. The third estimation model is a model that has learned a relationship between the musical playing operation data and a beat position, and may output the third estimation information associated with a beat position corresponding to the input data when the input data is provided.

According to an embodiment of the present disclosure, there is provided a data output method including sequentially obtaining input data related to a musical playing operation, obtaining a plurality of estimation information including first estimation information and third estimation information by providing the input data to a plurality of estimation models including a first estimation model and a third estimation model, identifying a musical score playing position corresponding to the input data based on the plurality of estimation information, and reproducing and outputting predetermined data based on the musical score playing position. The first estimation model is a model that indicates a relationship between musical playing operation data related to a musical playing operation and a musical score position in a predetermined musical score, and outputs the first estimation information associated with a musical score position corresponding to the input data when the input data is provided. The third estimation model is a model that indicates a relationship between the musical playing operation data and a beat position, and outputs the third estimation information associated with a beat position corresponding to the input data when the input data is provided.

At least one of the plurality of estimation models may include a learned model that has machine-learned the relationship.

Reproducing the predetermined data may include reproducing sound data.

The sound data may include singing sound.

Reproducing the sound data may include reading a waveform signal according to the musical score playing position and generating the singing sound.

Reproducing the sound data may include reading sound control information including character information and pitch information according to the musical score playing position and generating the singing sound.

The predetermined musical score may have a parallel pitch one octave below the highest pitch in at least some sections.

The input data provided to the first estimation model may include first input data from which a musical playing operation in a first pitch range is extracted and second input data from which a musical playing operation in a second pitch range is extracted.

The first estimation model may generate the first estimation information based on estimation information corresponding to a musical score position corresponding to the first input data and estimation information corresponding to a musical score position corresponding to the second input data.

A program may be provided to cause a processor to execute the data output method described above.

A data output device may be provided including the processor to execute the program described above.

A music instrument may be provided to include the data output device described above, a musical playing control element for inputting the musical playing operation, and a sound source unit generating musical playing operation sound data according to the musical playing operation.

What is claimed is:

1. A data output method comprising:
sequentially obtaining input data related to a musical playing operation;
obtaining a plurality of estimation information including first estimation information and second estimation information by providing the input data to a plurality of estimation models including a first estimation model and a second estimation model;
identifying a musical score playing position corresponding to the input data based on the plurality of estimation information; and
reproducing and outputting predetermined data based on the musical score playing position,
wherein
the first estimation model is a model that indicates a relationship between musical playing operation data related to a musical playing operation and a musical score position in a predetermined musical score, and outputs the first estimation information associated with a musical score position corresponding to the input data in response to the input data being provided, and
the second estimation model is a model that indicates a relationship between the musical playing operation data and a position in a measure, and outputs the second estimation information associated with a position in a measure corresponding to the input data in response to the input data being provided.

2. The data output method according to claim 1, wherein
the plurality of estimation models includes a third estimation model,
the plurality of estimation information includes third estimation information, and
the third estimation model is a model that has learned a relationship between the musical playing operation data and a beat position, and outputs the third estimation information associated with a beat position corresponding to the input data in response to the input data being provided.

3. The data output method according to claim 1, wherein at least one of the plurality of estimation models includes a learned model that has machine-learned the relationship.

4. The data output method according to claim 1, wherein reproducing the predetermined data includes reproducing sound data.

5. The data output method according to claim 4, wherein the sound data includes singing sound.

6. The data output method according to claim 5, wherein reproducing the sound data includes reading a waveform signal according to the musical score playing position and generating the singing sound.

7. The data output method according to claim 5, wherein reproducing the sound data includes reading sound control information including character information and pitch information according to the musical score playing position and generating the singing sound.

8. The data output method according to claim 1, wherein the predetermined musical score has a parallel pitch one octave below the highest pitch in at least some sections.

9. The data output method according to claim 1, wherein the input data provided to the first estimation model includes first input data from which a musical playing operation in a first pitch range is extracted and second input data from which a musical playing operation in a second pitch range is extracted.

10. The data output method according to claim 9, wherein the first estimation model generates the first estimation information based on estimation information corresponding to a musical score position corresponding to the first input data and estimation information corresponding to a musical score position corresponding to the second input data.

11. A data output method comprising:
sequentially obtaining input data related to a musical playing operation;
obtaining a plurality of estimation information including first estimation information and third estimation information by providing the input data to a plurality of estimation models including a first estimation model and a third estimation model;
identifying a musical score playing position corresponding to the input data based on the plurality of estimation information; and
reproducing and outputting predetermined data based on the musical score playing position,
wherein
the first estimation model is a model that indicates a relationship between musical playing operation data related to a musical playing operation and a musical score position in a predetermined musical score, and outputs the first estimation information associated with a musical score position corresponding to the input data in response to the input data being provided, and
the third estimation model is a model that indicates a relationship between the musical playing operation data and a beat position, and outputs the third estimation information associated with a beat position corresponding to the input data in response to the input data being provided.

12. The data output method according to claim 11, wherein at least one of the plurality of estimation models includes a learned model that has machine-learned the relationship.

13. The data output method according to claim 11, wherein reproducing the predetermined data includes reproducing sound data.

14. The data output method according to claim 13, wherein the sound data includes singing sound.

15. The data output method according to claim 14, wherein reproducing the sound data includes reading a waveform signal according to the musical score playing position and generating the singing sound.

16. The data output method according to claim 14, wherein reproducing the sound data includes reading sound control information including character information and pitch information according to the musical score playing position and generating the singing sound.

17. The data output method according to claim 11, wherein the predetermined musical score has a parallel pitch one octave below the highest pitch in at least some sections.

18. The data output method according to claim 11, wherein the input data provided to the first estimation model includes first input data from which a musical playing operation in a first pitch range is extracted and second input data from which a musical playing operation in a second pitch range is extracted.

19. The data output method according to claim 18, wherein the first estimation model generates the first estimation information based on estimation information corresponding to a musical score position corresponding to the first input data and estimation information corresponding to a musical score position corresponding to the second input data.

20. A data output device comprising:
a memory storing instructions and including a plurality of estimation models including a first estimation model and a second estimation model; and
a processor configured to implement the instructions to:
sequentially obtain input data related to a musical playing operation;
obtain a plurality of estimation information including first estimation information and second estimation information by providing the input data to the plurality of estimation models including the first estimation model and the second estimation model;
identify a musical score playing position corresponding to the input data based on the plurality of estimation information; and
reproduce and output predetermined data based on the musical score playing position,
wherein
the first estimation model is a model that indicates a relationship between musical playing operation data related to a musical playing operation and a musical score position in a predetermined musical score, and outputs the first estimation information associated with a musical score position corresponding to the input data in response to the input data being provided, and
the second estimation model is a model that indicates a relationship between the musical playing operation data and a position in a measure, and outputs the second estimation information associated with a position in a measure corresponding to the input data in response to the input data being provided.
